(19) United States
(12) Patent Application Publication
(10) Pub. No.: US 2010/0086891 A1
(43) Pub. Date: Apr. 8, 2010

(54) TOOTH WHITENING APPARATUS

(76) Inventor: Jong-Chan Jun, Gyeonggi-do (KR)

Correspondence Address: Jae Y. Park, Kile, Goekjian, Reed & McManus, PLLC, 1200 New Hampshire Ave. NW, Suite 570, Washington, DC, 20036, US

(21) Appl. No.: 12/519,214

(22) PCT Filed: Dec. 14, 2006
(86) PCT No.: PCT/KR2006/005453

§ 371 Date: Jun. 15, 2009

(51) Int. Cl. A61C 19/00

(52) U.S. Cl. 433/29

(57) ABSTRACT

Provided is a tooth whitening apparatus. The tooth whitening apparatus includes a whitening unit having a light emitting part emitting light to all of teeth of a patient; and a wearable set to which the whitening unit is mounted, the wearable set being worn on head of the patient.

### TECHNICAL FIELD

The present invention relates to a tooth whitening apparatus, and particularly, to a tooth whitening apparatus that includes a plurality of small chip LEDs at a light emitting part to improve whitening efficiency and is fixed on a patient's face to facilitate a whitening treatment.

### BACKGROUND ART

As interests in plastic surgery and cosmetic treatments increases, tooth whitening is considered one of the cosmetic treatments. Teeth can be stained on their surfaces by a variety of factors such as drugs, innate causes, smoking or food. Especially, the tooth whitening is receiving much attention from young women today as one of the cosmetic treatments.

However, a tooth whitening treatment requires long time and high costs, and a patient who undergoes the tooth whitening treatment must endure pain. Moreover, a patient of the tooth whitening treatment may be disappointed by the unsatisfactory whitening result, after the costly, time-consuming, painful process.

In the related art tooth whitening apparatus, a so-called lens light emitting device (LED) is sometimes used, which focuses emitted light to an optical angle of 20˜30° using a mounted lens. However, the tooth whitening apparatus has the following problems. Since one or two large-sized lens LEDs, each of which consumes power of 5 W or greater and has a narrow optical angle of 20-30° are used, power consumption is increased, tooth whitening efficiency is lowered, and only 2-3 teeth can be whitened at a time, which increases user's inconvenience.

### DISCLOSURE OF INVENTION

### Technical Problem

An object of the present invention is to provide a tooth whitening apparatus including a highly efficient light emitting part that resolves disadvantages of the related art tooth whitening apparatus.

An object of the present invention is to provide a tooth whitening apparatus capable of whitening all of teeth through one tooth whitening treatment.

Another object of the present invention is to provide a tooth whitening apparatus, which is wearable on a patient's head or neck to help the patient be more comfortable during the tooth whitening treatment.

### Technical Solution

In one aspect of the present invention, there is provided a tooth whitening apparatus including: a whitening unit having a light emitting part in order to emit light to all of teeth of a patient; and a wearable set to which the whitening unit is mounted, the wearable set being worn on head of the patient.

### ADVANTAGEOUS EFFECTS

A tooth whitening apparatus according to the present invention can maximize efficiency of a light emitting part for tooth whitening.

A tooth whitening apparatus according to the present invention can be used as a photopolymerizer used for both tooth whitening and hardening of a dental photopolymerization resin.

A tooth whitening apparatus according to the present invention can achieve a sufficient whitening effect at one-time treatment within one hour, as compared to the related art tooth whitening apparatus that shows visible whitening effects after a patient receives a tooth whitening treatment several times.

A tooth whitening apparatus according to the present invention can be used as a photopolymerizer for a resin filled in a tooth cavity by controlling the intensity of a current.

A tooth whitening apparatus according to the present invention can whiten all of teeth at a time, as compared to the related art tooth whitening apparatus that can whiten only one or two teeth at a time.

A tooth whitening apparatus according to the present invention can increase a usable time of a rechargeable battery by using a chip LED using a low current, as compared to a usable time of the related art tooth whitening apparatus using an excessive current.

### BRIEF DESCRIPTION OF THE DRAWINGS

FIG. 1 is a perspective view illustrating a whitening unit of a tooth whitening apparatus according to an embodiment of the present invention;

FIGS. 2 and 3 are a plan view and a cross-sectional view of a light emitting part constituting a whitening unit of a tooth whitening apparatus according to an embodiment of the present invention, respectively;

FIGS. 4 and 5 illustrate a light emitting part of a tooth whitening apparatus according to another embodiment of the present invention;

FIGS. 6 and 7 are a plan view and a cross-sectional view of a light emitting part constituting a whitening unit of a tooth whitening apparatus according to another embodiment of the present invention;

FIGS. 8 and 9 illustrate a body of a light emitting part constituting a whitening unit of a tooth whitening apparatus according to an embodiment the present invention;

FIG. 10 is a perspective view of a wearable set for a tooth whitening apparatus according to an embodiment the present invention;

FIG. 11 is a perspective view illustrating that a whitening unit and a wearable set are coupled according to an embodiment the present invention;

FIG. 12 illustrates a mouthpiece for fixing a whitening unit of a tooth whitening apparatus and the mouth of a patient according to an embodiment of the present invention;

FIG. 13 is an upper view of a tooth whitening apparatus according to the present invention, illustrating that a tooth whitening unit, a wearable set and a mouth adhering part are all coupled;

FIG. 14 is a rear view of a tooth whitening apparatus viewed from a side of a support supporting the neck or the back of the head of a patient;

FIG. 15 is a rear view of a tooth whitening apparatus viewed from a connector side of the tooth whitening unit;

FIG. 16 is a side view of a tooth whitening apparatus; and

FIGS. 17 through 19 are a side view, a rear view, and a front view of a platform for a tooth whitening apparatus according to an embodiment of the present invention, respectively.

### BEST MODE FOR CARRYING OUT THE INVENTION

Embodiments of the present invention will now be described in detail with reference to accompanying drawings.

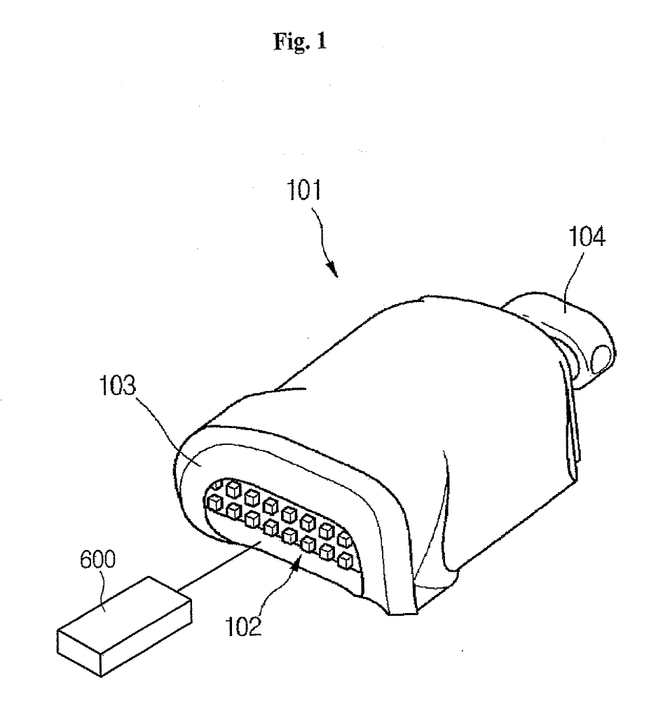

FIG. 1 is a perspective view illustrating a whitening unit 101 of a tooth whitening apparatus according to an embodiment of the present invention.

The whitening unit 101 according to the present invention includes a light emitting part 102 including a plurality of chip light emitting devices (LEDs) to emit light to teeth, a mouth adhering part 103 adhering to the mouth of a patient at the time of tooth whitening, and a connector 104 coupling the tooth whitening apparatus 100 to a guide.

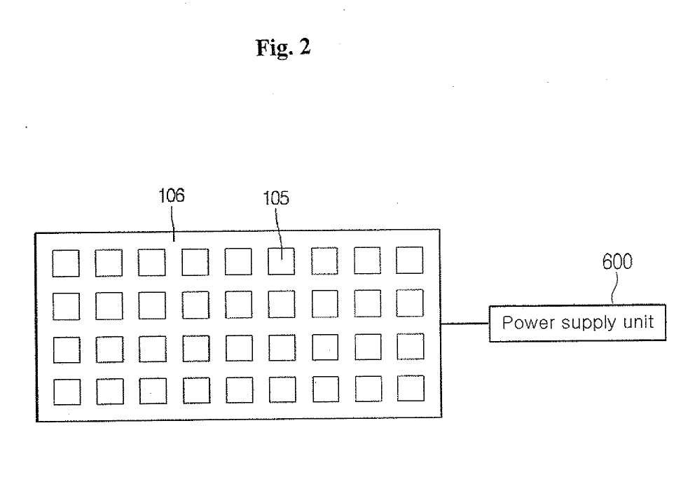

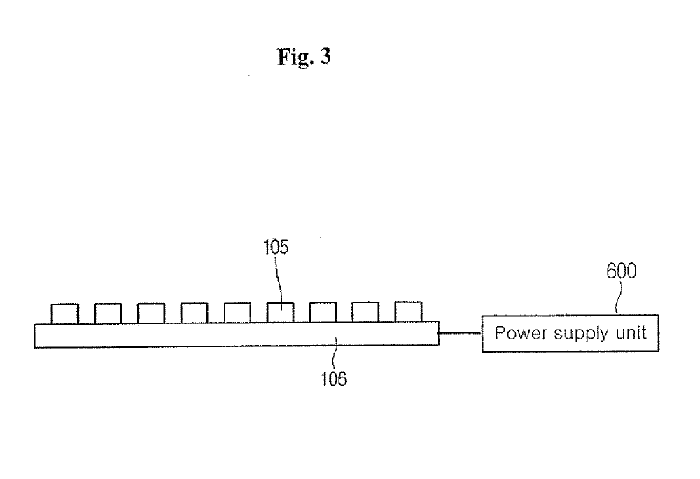

FIGS. 2 and 3 are a plan view and a cross-sectional view of the light emitting part 102, respectively.

Referring to FIG. 2, the light emitting part 102 includes a plurality of light emitting devices 105 arranged on a planar printed circuit board (PCB) 106. Chip LEDs may be used as the light emitting devices 105.

There are various types of LEDs including a high brightness diffusion LED, and a hyper LED used for an indoor lamp or a break lamp. Of those LEDs, a chip LED can be mounted in the same way that an IC chip is mounted, and is smaller than other types of LEDs. Also, the chip LED is a light emitting device that is used for a backlight of a liquid crystal display (LCD) device, for example, a mobile phone or an MP3 player.

The size of the chip LED used as the light emitting device according to the present invention may vary depending on embodiments. Here, the size of the chip LED may be slightly smaller than or almost the same as the size of a human tooth. The chip LED used as the light emitting device 105 may have an area of 3.5 mm×2.8 mm, and a height of 0.4 mm.

An optical angle of the light emitting device 105 according to the present invention may range from about 120° to 130° in a light emission direction of the light emitting device 105.

Light emitted by the chip LEDs (102 of FIG. 1) according to the present invention must be visible rays with a wavelength of 380-520 nm, and preferably, blue rays with a wavelength of 460 nm.

The visible rays are emitted after whitening chemicals are applied on teeth so as to more efficiently put the whitening chemicals into the teeth.

Depending on embodiments, a metal halide lamp may be used as the light emitting device 105 according to the present invention, besides the chip LED. When the metal halide lamp is used as the light emitting device 105, a heat release fan may be mounted for cooling.

The chip LEDs used as the light emitting devices 105 of the whitening unit 101 of the tooth whitening apparatus according to the present invention require a low current of 100 mA-120 mA. A sufficient whitening effect can be obtained when such chip LEDs approach patient's teeth at a distance of 1˜4 cm and emit light for about 8 minutes or longer.

Also, a current applied to the light emitting device 105 of the whitening unit 101 is adjusted depending on a state of the patient's teeth, so that a whitening time can be shortened, or light of only appropriate intensity can be applied. In such a manner, a whitening treatment suitable for the state of the patient's teeth can be performed.

Depending on embodiments, a timer may be set at a power of a current being applied to the light emitting devices 105, so that the power can be automatically turned off when a predetermined whitening time is elapsed.

Also, if a current being applied to the light emitting devices 105 of the whitening unit 101 of the tooth whitening apparatus according to the present invention is increased up to 300 mA 350 mA, the light emitting device 105 may act as a curing device that hardens a dental resin or other tooth curing resins filled in a cavity through a photopolymerization process at the time of a dental treatment. Sufficient hardening is achieved as the light emitting devices 105 approach a dental resin applied to patient's teeth at a distance shorter than 1 cm, and emit light for about two minutes in a state where a current of 300 mA 350 mA is applied thereto.

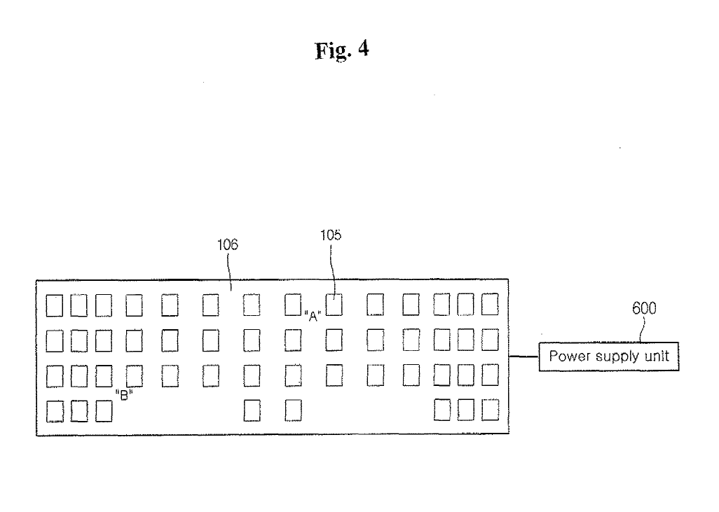

FIG. 4 is a plan view of a light emitting part 102 according to another embodiment of the present invention.

As for the human teeth, a density of the teeth in a central portion A where front teeth and canine teeth are placed is greater than that in a peripheral portion B where molar teeth are placed. Also, the peripheral portion. B is spaced further away from the light emitting devices 105 than the central portion A because of structural features of the teeth. For this reason, when the same light is emitted, the light is concentratively emitted only to the central portion A. In this regard, the light emitting devices 105 are disposed with a relatively low density in the central portion A, and are relatively densely disposed in the peripheral portion B, so that the tooth whitening effect can be improved.

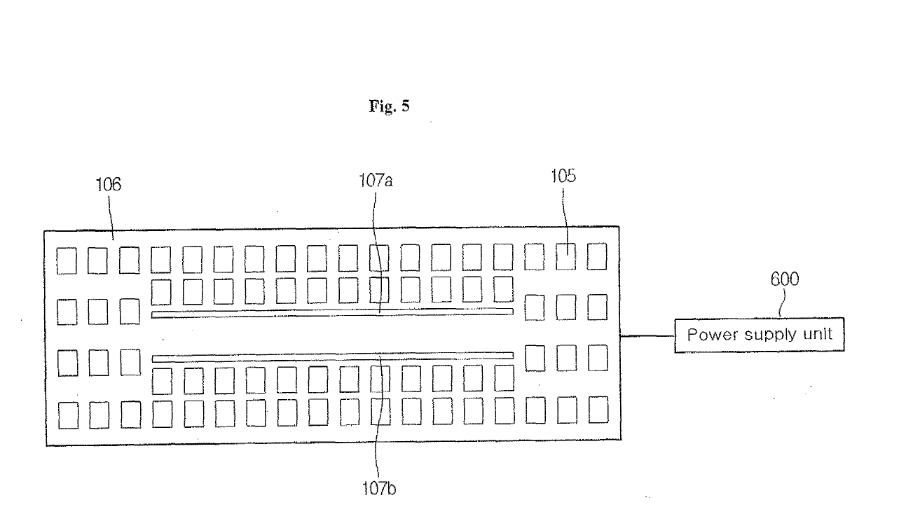

FIG. 5 is a plan view of a light emitting part 102 according to another embodiment of the present invention.

A patient receives the tooth whitening treatment with the mouth open. However, when the mouth is open, a space where no teeth are present exists in the mouth, and there is no need to illuminate the space where no teeth are present. In this regard, mirrors 107a and 107b are disposed at the center of the tooth whitening unit, so as to reflect light being emitted to the center of the mouth, upwardly and downwardly. Hence, the tooth whitening effect can be increased.

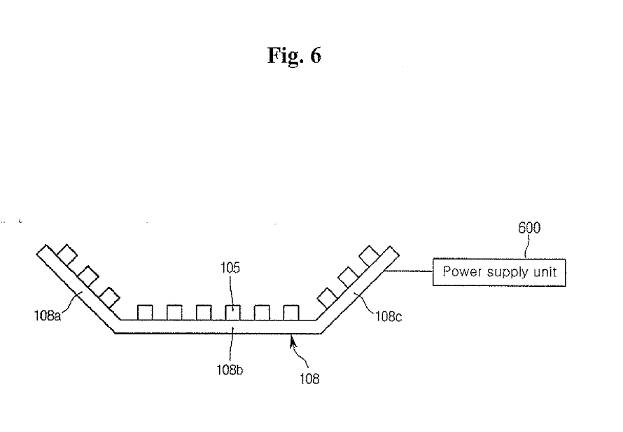

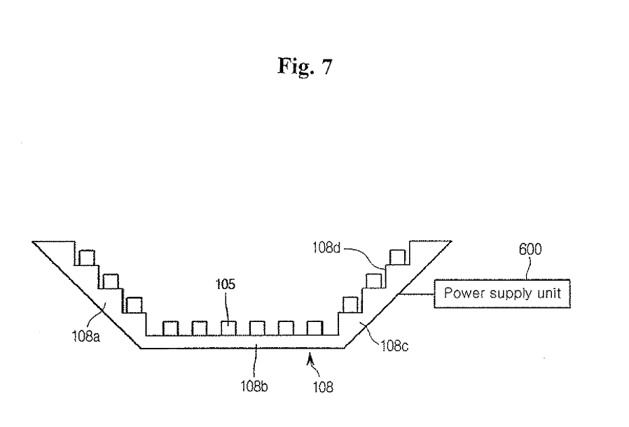

FIGS. 6 and 7 are cross-sectional views of a light emitting part 102 according to another embodiment of the present invention.

Referring to FIG. 6, light emitting devices 105 may be disposed on a PCB 108 including three faces 108a, 108b and 108c, instead of the planar PCB of FIG. 2.

Light emitting devices 105 on the lateral faces 108a and 108c of the PCB 108 emit light mainly to the molar teeth, and light emitting devices 105 on the center face 108b of the PCB 108 emit light mainly to the front teeth or the canine teeth. Such arrangement allows more uniform light emission to the central portion and the peripheral portion of the human teeth.

Also, referring to FIG. 7, each lateral face 108a and 108c of the PCB 108 may have a plurality of step portions 108d. In a structure as illustrated in FIG. 7, light emitted from the light emitting devices 105 is made incident vertically upon the teeth, so that the tooth whitening effect can be improved.

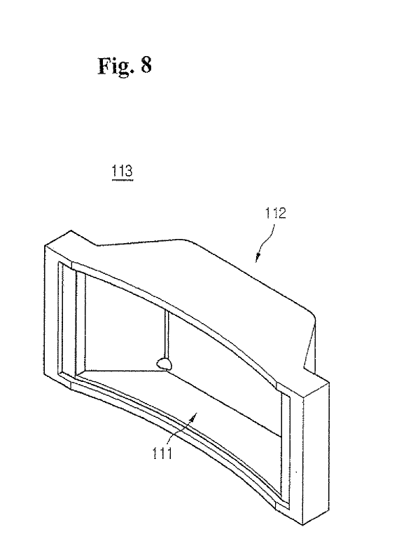

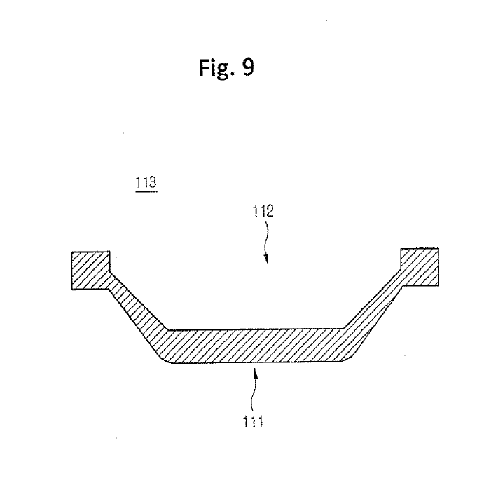

FIGS. 8 and 9 illustrate a body 113 of the light emitting part 102 constituting the tooth whitening unit 101 according to an embodiment the present invention. The body 113 is disposed inside a case of a whitening unit (101 of FIG. 1), and is provided with a PCB illustrated in FIGS. 2 through 7, and acts as a frame of the tooth whitening unit 101.

The body 113 may be made of a metal material, preferably, aluminum. A PCB including light emitting devices 105, that is, a light emitting part 102, is mounted at a front side of the body 113, and a cooling plate (not shown) cooling the light emitting devices 105 or a fan (not shown) for heat release may be disposed at a rear side 112 of the body 113.

The light emitting part 102 of the whitening unit 101 according to the present invention requires a power supply unit (600) supplying DC power of 4.5 V. The power may be supplied through the cable from the outside, or may be supplied by installing a battery, such as a disposable battery or a rechargeable battery, in the whitening unit 101. Here, the battery installed in the whitening unit 101 increases a weight of the whitening unit 101, which makes it difficult for a patient to wear the whitening unit 101 for the tooth whitening treatment. For this reason, it is more preferable to supply power through the cable from the outside. Current intensity of the power supplied to the light emitting part (102) of the whitening unit (101) by the power supply device (600) is controllable.

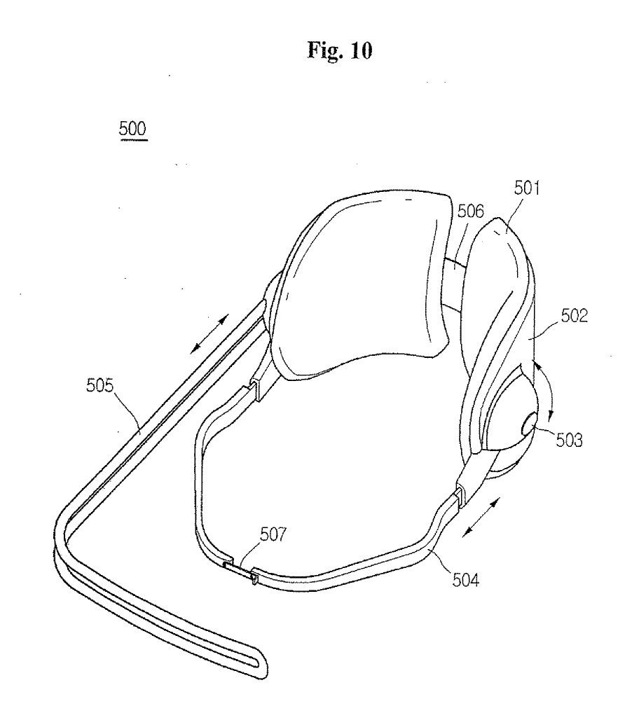

FIG. 10 is a perspective view of a wearable set 500 of a tooth whitening apparatus according to an embodiment of the present invention.

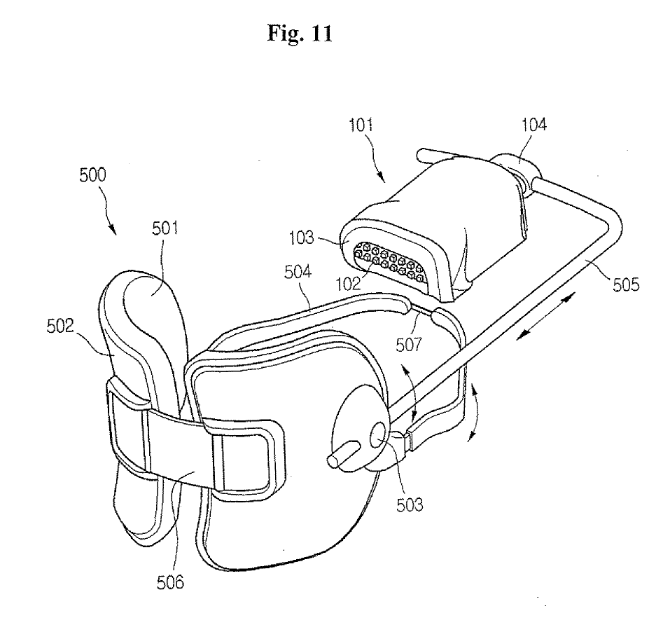

As illustrated in FIG. 11, a whitening unit 101 may be coupled to a wearable set 500 for use according to an embodiment of the present invention.

Referring to FIGS. 10 and 11, the wearable set 500 of the tooth whitening apparatus according to the present invention includes a support 501 closely attached to the neck or the back of the head for supporting, a jaw fixing part 504 extending from the support 501 and fixing the jaw, and a guide 505 extending from the support 501 and coupled to a connector 104 of a whitening unit 101.

The support 501 is closely attached to the neck or the back of the head of a patient, and may be formed as a flexible pad to improve a wearing feeling. Also, as illustrated in FIG. 10, the support 501 may be divided into a left support and a right support to improve a wearing feeling, and the left support and the right support may be connected together by a connection cord 506 having flexibility.

When the support 501 is formed as a pad having flexibility, a support plate 502 may be formed to support a rear side of the support 501.

The jaw fixing part 504 is fixed to the support 501 or the support plate 502 by a rotary connection part 502, and is rotatable in upward and downward directions as indicated by an arrow in the drawing. Also, as indicated as an arrow in the drawing, the jaw fixing part 504 may be drawn in and out in forward and backward directions, corresponding to the size of the patient's head.

A fastener 507 is formed at a portion of the jaw fixing part 504 coupled to the jaw, and may be fastened or released if necessary.

The guide 505 is inserted in a hole provided in the connector 104 of the whitening unit 101. The whitening unit 101 is movable along the guide 505, and so that a position of the whitening unit 101 can be controlled corresponding to the jaw of a patient. The guide 505 extends frontward to a predetermined length, is bent in a horizontal direction, and can be rotated to a predetermined angle.

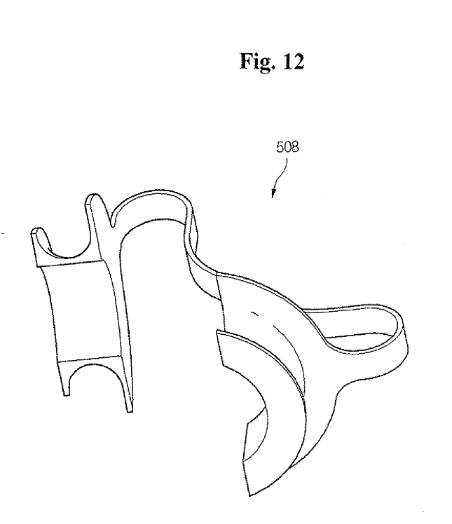

FIG. 12 illustrates a mouthpiece 508 hold in the mouth of a patient to fix the mouth adhering part 103 and the mouth of the patient. The mouthpiece 508 places and fixes teeth at an exact position to which the whitening unit 101 emits light.

The mouthpiece 508 and the whitening unit 101 may be undesirably separated from each other as the patient moves while having the tooth whitening treatment in a state of holding the mouthpiece 508 in the mouth with the mouth attached to the whitening unit 101. Therefore, a groove or a protrusion is provided at a portion of the whitening unit 101 contacting the mouthpiece 508, and a combiner (not shown) connecting the mouthpiece 508 with the groove or the protrusion is additionally mounted, so that the mouthpiece 508 and the whitening unit 101 can be firmly fixed.

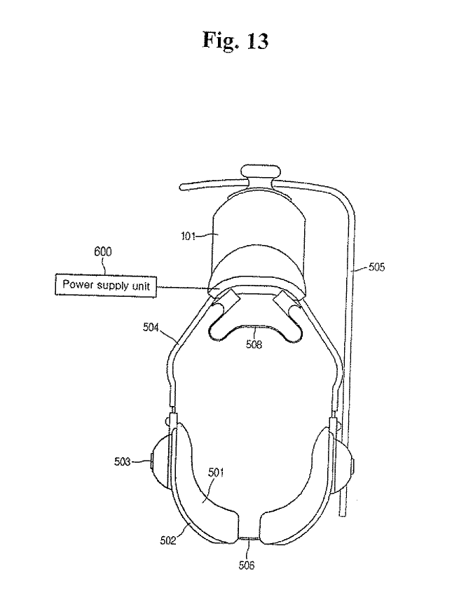

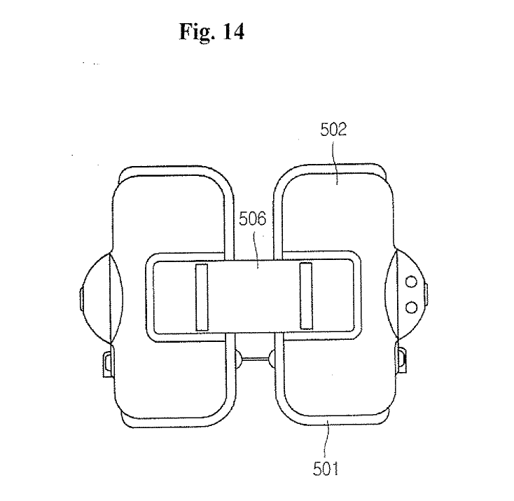

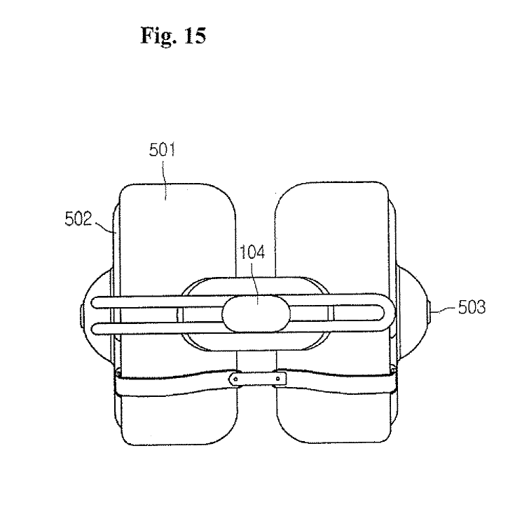

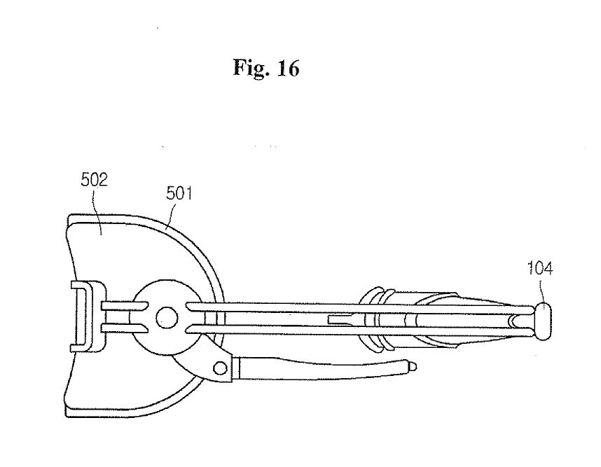

FIG. 13 is an upper view of a tooth whitening apparatus according to the present invention, illustrating that a tooth whitening unit 101, a wearable set 500 and a mouth adhering part 103 are all coupled. FIG. 14 is a rear view of a tooth whitening apparatus viewed from a side of a support 501 supporting the neck or the back of the head of a patient. FIG. 15 is a rear view of a tooth whitening apparatus viewed from a connector side of the whitening unit 101, and FIG. 16 is a side view thereof.

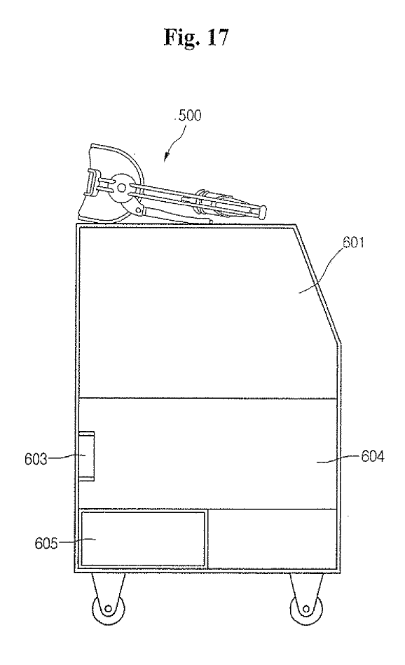

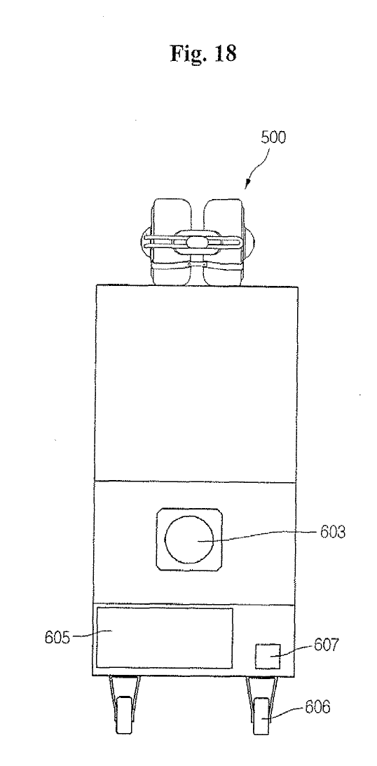

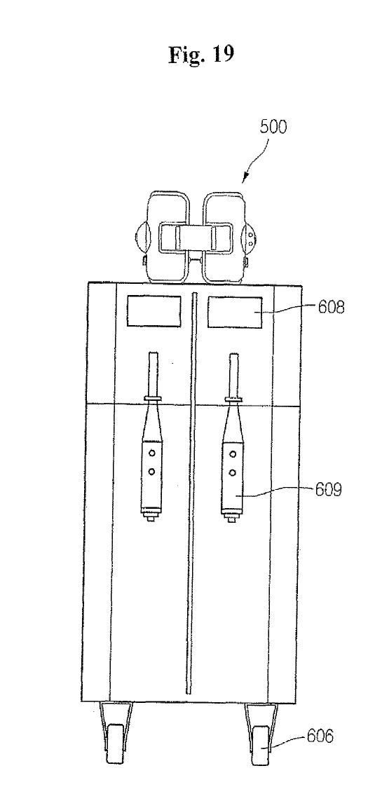

FIGS. 17 through 19 are a side view, a rear view, and a front view of a platform for a tooth whitening apparatus according to an embodiment of the present invention, respectively.

Referring to FIGS. 17, 18 and 19, the platform for a tooth whitening apparatus including a wearable set 500 according to the present invention includes a PCB unit 601 on which a plurality of circuits for controlling power and a tooth whitening apparatus are mounted, a rechargeable unit 605 supplying power to the tooth whitening apparatus, and at least one control panel unit 608 providing an interface for controlling power and operation of the tooth whitening apparatus through the circuits mounted on the PCB unit 601.

The platform of the tooth whitening apparatus according to the present invention is connected to a whitening unit 101 of the tooth whitening apparatus by a power cable, and rectifies AC power of 100 V˜220 V to predetermined DC power, for example, DC power of 4.5 V, and supplies the DC power to chip LEDs constituting a light emitting part of the whitening unit 101.

AC power is applied to a converter 604 through a power supplier 607 from the outside. The converter 604 rectifies the applied AC power to DC power of 12V. An example of the converter 604 is a switching mode power supply (SMPS), which is an AC/DC converter that converts AC electricity of 100 V-220 V into DC electricity of 5-48 V.

Besides voltage converting, the converter can change the intensity of current being applied to the whitening unit of the tooth whitening apparatus. When a low current of 100 mA˜120 mA is applied to the tooth whitening unit of the tooth whitening apparatus, the converter 604 may be used for the tooth whitening. Also, when the current is increased up to 300 mA˜350 mA, the converter 604 may be used as a curing device for photopolymerization.

A fan 603 may be installed at the converter 604 in order to release heat generated at the time of voltage or current conversion, or heat generated from the rechargeable unit 605.

The rechargeable unit 605 is charged with the DC power rectified by the converter 604. The DC power of 12 V charged in the rechargeable unit 605 is reduced to DC power of 4.5 V, and the DC power of 4.5 V is supplied to chip LEDs constituting the light emitting part of the whitening unit 101.

The control panel unit 608 includes a screen of a liquid crystal display (LCD) device or a plasma display panel that displays an operational state and a setting state of the tooth whitening apparatus, and allows setting or controlling of power, operation time, the intensity of light of the tooth whitening apparatus.

A mounting portion for a spot curing device 609 may be installed in the platform for the tooth whitening apparatus according to the present invention. The spot curing device 609 is dedicated to hardening of a resin filled in a cavity of a tooth or other resins for dental care. A use current of the spot curing device 609 is 300˜350 mA, and receives a current converted by the converter 604.

Also, a roller 606 allowing a free movement may be mounted at a lower end of the platform for the tooth whitening apparatus.

It will be apparent to those skilled in the art that various modifications and variations can be made in the present invention. Thus, it is intended that the present invention covers the modifications and variations of this invention provided they come within the scope of the appended claims and their equivalents.

1-18. (canceled)

19. A tooth whitening apparatus comprising:
a whitening unit (101) including a light emitting part (102) emitting light to all of teeth of a patient; and
a wearable set (500) to which the whitening unit (101) is mounted, the wearable set (500) being worn on head of the patient.

20. The apparatus according to claim 19, further comprising a power supply unit (600) applying power to the light emitting part (102).

21. The apparatus according to claim 20, wherein current intensity of the power applied to the light emitting part (102) by the power supply unit (600) is controllable.

22. The apparatus according to claim 19, wherein the wearable set (500) includes a support (501) to support a neck or a head of the patient; a jaw fixing part (504) extending from the support (501) to fix the jaw of the patient; and a guide (505) extending from the support (501) and coupled to the whitening unit (101).

23. The apparatus according to claim 22, further comprising a connector (104) to couple the whitening unit (101) to the guide (505).

24. The apparatus according to claim 19, further comprising a mouthpiece (508) coupled to a mouth adhering part (103) of the whitening unit (100), the mouth piece (508) being held in the mouth of the patient.

25. The apparatus according to claim 23, wherein the whitening unit (101) is moveable along the guide (505) in a predetermined distance.

26. The apparatus according to claim 19, wherein the light emitting part (102) includes a planar substrate (106); and a plurality of chip light emitting devices (105) mounted on the planar substrate (106) to emit the light.

27. The apparatus according to claim 19, wherein the light emitting part (102) includes a substrate (108) having a plurality faces to surround a mouth of the patient; and a plurality of chip light emitting devices (105) mounted on the substrate (108) to emit the light.

28. The apparatus according to claim 27, wherein the substrate (108) includes three faces (108a, 108b, and 108c).

29. The apparatus according to claim 28, wherein each lateral face (108a, 108c) of the substrate (108) has a plurality step portions (108d).

30. The apparatus according to claim 26, wherein a number of the chip light emitting devices (105) on a lateral side of the planar substrate (106) is greater than a number of the chip light emitting devices (105) mounted on central portion of the planar substrate (106).

31. The apparatus according to claim 26, further comprising reflective plates (107a, 107b) disposed on a central side of the planar substrate (106).
